(19) United States
(12) Patent Application Publication
(10) Pub. No.: US 2005/0231471 A1
(43) Pub. Date: Oct. 20, 2005

(54) Hand covering features for the manipulation of small devices

(75) Inventors: David E. Mallard, New York, NY (US); Stuart M. Leslie, Larchmont, NY (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: 4SIGHT, INC.

(21) Appl. No.: 11/110,316

(22) Filed: Apr. 19, 2005

Related U.S. Application Data
(60) Provisional application No. 60/563,277, filed on Apr. 19, 2004.

(51) Int. Cl. G09G 5/00

(52) U.S. Cl. 345/156

(57) ABSTRACT

A hand covering worn by a user has one or more input gesture features for enabling the user to effectively make input gestures for manipulating a small device without requiring removal of the hand covering. In a preferred embodiment, at least one instance of conductive material is provided for effectively transferring a required amount of charge between the user and a capacitive interface of the device.

### CROSS REFERENCE TO RELATED APPLICATION

This claims the benefit of U.S. Provisional Patent Application No. 60/563,277, filed Apr. 19, 2004, which is hereby incorporated by reference herein in its entirety.

### BACKGROUND OF THE INVENTION

This invention relates to articles of clothing adapted to the hand of a user, such as gloves, mittens, or the like, and, more particularly, to such hand coverings provided with features that enable the user to effectively make input gestures for manipulating a small device without requiring removal of the hand covering.

It should be noted that the term “hand covering” will be used herein to designate the aforementioned articles of clothing only for purposes of simplicity, and is not intended to limit the present invention specifically to one particular type. It should also be noted that the term “digit” will be used herein generally to refer to not only a thumb, but also to any or all of the other fingers on a user's hand (i.e., index, middle, ring, and little fingers), and is not intended to limit the present invention specifically to one particular type.

Advances in electronics technology are leading to ever-smaller device designs with an ever-increasing variety of applications. Many “computing” devices, including handheld computers, Personal Digital Assistants (“PDAs”), pagers, personal entertainment systems, and cellular telephones, are now small enough to be easily carried by the user.

One of the most important factors contributing to the size and effective use of these devices is the interface between the device and a person using it. However, highly miniaturized computing devices have significant operational limitations as a consequence of their small size. In particular, the small size greatly restricts possible approaches for data input and, therefore, the computer-human interface is highly constrained. Traditional desktop computer-human interfaces, those that rely on keyboards and pointing devices (e.g., a “mouse” or “trackball”), translate poorly to very small devices.

Some handheld computer designs attempt to mimic desktop computer designs, however, only a miniature keyboard can be included. Typically, PDAs lack a keyboard altogether. In response to this problem, these small computing devices generally provide for data input through a limited number of smaller buttons. Other miniature portable devices, such as pagers and cellular telephones, also typically rely on small buttons for command input.

Certain approaches to the computer-human command submission interface have the goal of improving the interface for smaller handheld electronic devices using touch-sensing technology. For example, one approach is to employ two-dimensional interactive “trackpads,” which bring mouse-like cursor functionality to these handheld computing devices. An other approach is to equip small computing devices with an interactive “touchscreen” display, such that the devices receive control commands by a user touching a portion of the display screen.

Different touch-sensing interfaces (e.g., trackpads and touchscreens) operate on different electrical principles to sense the placement and movement of a user's touch. Some utilize resistive-type systems, which typically include a resistive layer of material and a conductive layer of material that are positioned close together and separated by a small air gap. When a user touches a screen or pad of the resistive type, the two layers make contact in that exact spot, and the change in the electrical field is noted and the coordinates of the point of contact are calculated by the host computing device. Other touch-sensing interfaces utilize capacitive-type systems, which typically include one conductive layer of material that stores electrical charge. When a user touches a screen or pad of the conductive type, some amount of charge is transferred between the user and the screen or pad, such that the charge on the capacitive layer changes. This change is noted and the coordinates of the point of contact are calculated by the host computing device. Yet another type of touch-sensing interface utilizes a surface acoustic wave system, wherein two transducers (one receiving and one sending) and two associated reflectors are placed along the x- and y-axes of a screen or pad. When a user touches a screen or pad of this type, the receiving transducer is able to tell if a wave transmitted by the sending transducer has been disturbed by a touch event at any instant. This event is noted and the coordinates of the point of contact are calculated by the host computing device.

A main difference between touch-sensing interfaces of the resistive, conductive, and acoustic wave types is in which stimuli will register as a touch event. A resistive system registers a touch as long as the two layers make contact, such that it doesn't matter if a user touches the screen or pad with a bare finger, a stylus pen, or any other imaginable object of a suitable size. Similarly, an acoustic wave system registers a touch as long as a transmitted wave is disturbed, such that practically any imaginable object of a suitable size may be used as an input. A capacitive system, on the other hand, requires a conductive input, typically a user's bare finger, in order to register a touch.

Both capacitive and resistive touch-sensing technologies are used in a variety of typical handheld computing devices, such as laptops, PDAs, and some of the most popular portable entertainment systems today (e.g., the clickable wheel-shaped capacitive trackpad found on the iPod mini by Apple Computer, Inc.). This touch-sensing technology enables intuitive navigation through content, such as play lists and menus, and can incorporate capacitive and resistive buttons to add selection capabilities while replacing mechanical buttons on the ever-shrinking electronic device designs.

As personal computing devices become smaller and more compact, it follows that the size of their touchscreens and trackpads is also sought to be reduced. Successfully entering a command is dependent upon the user being able to effectively make input gestures for contacting the touch-sensitive interface in a limited area in a manner which will manipulate the computing device as desired. Often times, a personal computing device utilizing a resistive touch-sensing interface is provided with a thin elongated stylus, which the user holds in one hand in contact with the screen or pad to operate the device, thereby allowing a significant reduction in the size of the resistive interface. While, on the other hand, a personal computing device utilizing capacitive touch-sensing technology typically requires interaction with the conductivity of the user's bare finger, thereby limiting the possible size reduction of the capacitive interface.

In addition to the problem of command input, small electronic devices must maximize the convenience of their portability and physical accessibility due to the ever-increasing frequency of their use. Portable devices typically must be carried in a pocket, a bag, or by hand. During use, they typically must be held in a hand or placed on a surface while a stylus or the digits of the other hand provide data entry. Moreover, although many of the above-described features for improving the computer-human command submission interface of small devices are tailored for direct interaction with a user's bare fingers (e.g., the size of miniature buttons, the electrical properties of capacitive touch-sensing trackpads and touchscreens, etc.), they still prove to be rather difficult to isolate or otherwise control due to the relatively broad surface of a user's fingertip. These difficulties are exacerbated when the user is wearing gloves or any other type of hand covering.

Gloves or mittens utilized for cold weather protection depend on bulk to obtain good thermal comfort. As their bulk or thickness is increased, however, the user's ability to detect, for example, the shape and feel of external devices, is diminished. A similar problem exists with respect to work gloves used to protect one's hands and fingers from heat, other environmental irritants, hazards, or injury. The relatively thick and tough material often utilized in the construction of work gloves also results in a loss of tactile sensitivity. Therefore, hand coverings inherently increase the workable surface of the user's fingertips and decrease the user's dexterity therewith, both tactilely and visually. In the past, when a wearer of hand coverings wished to use his or her cellular telephone, PDA, portable entertainment system, or any other small device requiring dexterity with a stylus and/or the electrical properties of a bare hand, it has been necessary for the user to remove the covering from his or her entire hand, or at least from a single digit, in order to effectively make input gestures for manipulating the device.

Accordingly, it would be advantageous to be able to provide hand covering features that allow a user to effectively make input gestures for manipulating a small device without requiring removal of the hand covering.

### SUMMARY OF THE INVENTION

It is an object of this invention to provide hand covering features that allow a user to effectively make input gestures for manipulating a small device without requiring removal of the hand covering.

In accordance with the present invention, there is provided a protective hand covering for providing a wearer of the hand covering with the ability to effectively make input gestures for manipulating a device. The hand covering has at least a first digit covering portion for surrounding a first digit of the wearer, and a first pointer member extending from the first digit covering portion.

### BRIEF DESCRIPTION OF THE DRAWINGS

The above and other advantages of the invention will be more apparent upon consideration of the following detailed description, taken in conjunction with the accompanying drawings, in which like reference characters refer to like parts throughout, and in which:

FIG. 1 is a side elevational view of a hand covering incorporating input gesture features according to the present invention;

FIG. 2 is a front elevational view of the hand covering of FIG. 1, taken from line 2-2 of FIG. 1;

FIG. 3 is a rear elevational view of the hand covering of FIGS. 1 and 2, taken from line 3-3 of FIG. 1;

FIG. 4 is a cross-sectional view of the hand covering of FIGS. 1-3, taken from line 4-4 of FIG. 2;

FIG. 5 is a cross-sectional view of the hand covering of FIGS. 1-4, taken from line 5-5 of FIG. 2;

FIG. 6 is a cross-sectional view of the hand covering of FIGS. 1-5, taken from line 6-6 of FIG. 2;

FIG. 7 is a cross-sectional view of the hand covering of FIGS. 1-6, taken from line 7-7 of FIG. 2;

FIG. 8 is a cross-sectional view of the hand covering of FIGS. 1-7, similar to FIG. 5, but demonstrating a first gesticulation configuration, interacting with a first type of device;

FIG. 9 is a cross-sectional view of the hand covering of FIGS. 1-8, similar to FIGS. 5 and 6, but demonstrating a second gesticulation configuration, interacting with another type of device;

FIG. 10 is a cross-sectional view of the hand covering of FIGS. 1-9, taken from line 10-10 of FIG. 2;

FIG. 11 is a side elevational view of a particular type of input gesture feature according to the present invention; and

FIG. 12 is a cross-sectional view of the hand covering of FIGS. 1-10, similar to FIG. 6, but also incorporating the particular type of input gesture feature of FIG. 11.

### DETAILED DESCRIPTION OF THE INVENTION

The present invention provides input gesture features for hand coverings worn by a user that enable the user to effectively make input gestures for manipulating a small device without requiring removal of the hand covering. A hand covering is preferably provided with at least one digit covering portion for surrounding a first digit of the user. Preferably, at least one pointer member is provided to extend from the digit covering portion, such that a free end of the pointer member may be maneuvered, through movement of the user's first digit, to effectively manipulate the device. Alternatively, or in addition to a pointer member, at least one instance of conductive material is provided on the hand covering, such that, when the hand covering is in contact with a capacitive interface of the device, the instance of conductive material may effectively transfer a required amount of charge between the interface and the user. In a particularly preferred embodiment of the present invention, the instance of conductive material will be provided by a pointer member. Preferably, the input gesture features are removeably attachable to any hand covering.

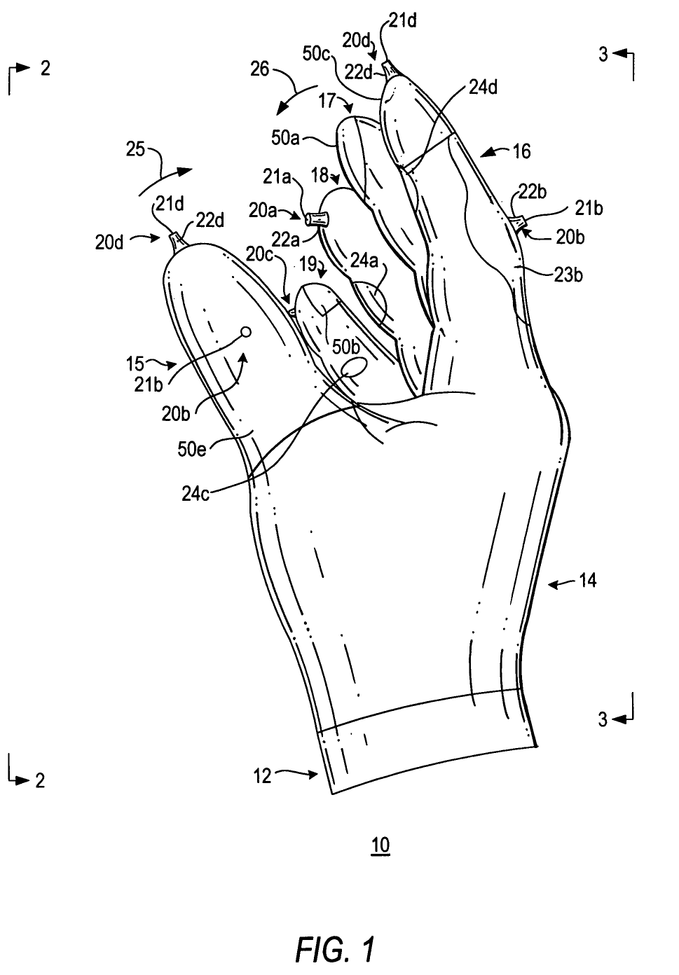

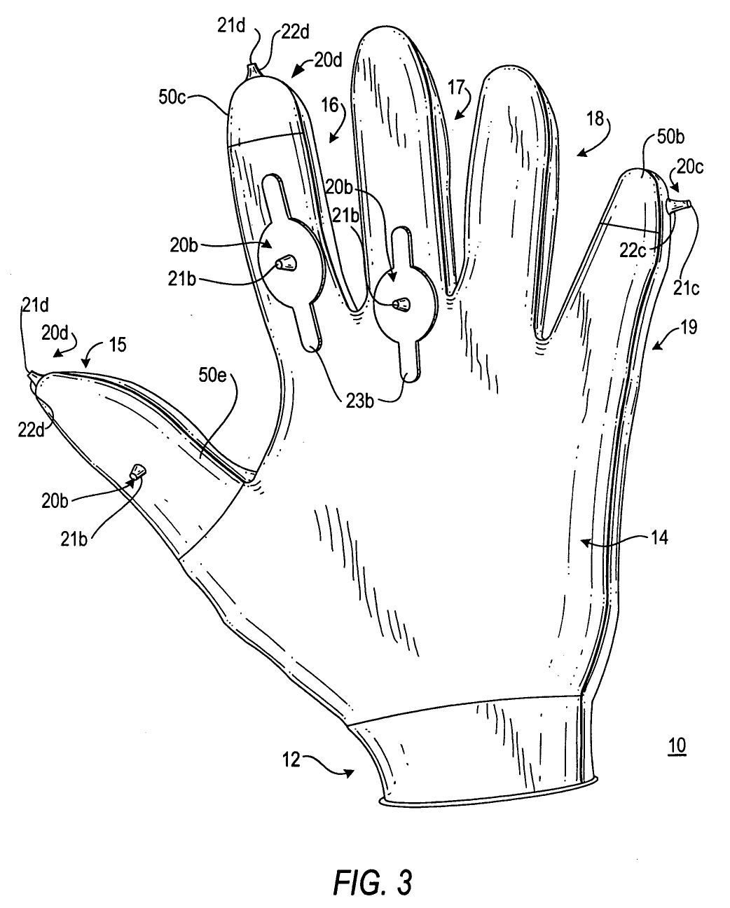

The invention will now be described with reference to FIGS. 1-12.

FIGS. 1-3 show a hand covering or glove 10 bearing a plurality of input gesture features 20 and 50 according to the present invention. Glove 10 has a wrist covering portion 12, a palm covering portion 14, a thumb covering portion 15, an index finger covering portion 16, a middle finger covering portion 17, a ring finger covering portion 18, and a little finger covering portion 19. It should be understood that coverings 12 and 14-19 may each be constructed of the same or different pieces or types of material, and in any manner known in the art, but that they are referred to as separate elements herein for the sake of clarity. Moreover, it should be understood that hand coverings of the present invention are not limited to gloves having individual finger covering sections, but also apply, for example, to unfingered mittens where the outer surfaces of the palm and fingers are all covered by a single covering portion, as is well known in the art. The hand coverings of the present invention (e.g., glove 10) may be formed from any suitable material, such as, but not limited to, leather, cotton, plastic, fiber composite, nylon, performance laminate, netting, rubber, canvas, or any combinations thereof.

Hand covering or glove 10 is preferably provided with one or more pointer members 20 (see FIGS. 1-10 and 12). Preferably, each pointer member 20 extends, substantially rigidly, from a digit covering portion 15-19, such that movement of the user's digit associated with that digit covering portion may accordingly maneuver the pointer member 20 to make effective input gestures for manipulating a small device without requiring removal of the hand covering. Each pointer member 20 has a body 22 with an exposed contact end 21. Contact end 21 of each pointer member 20 preferably serves as the primary portion of member 20 that contacts and interacts with the device to be manipulated by the user. It is to be appreciated that the size, shape, and material of both end 21 and body 22 of each pointer member 20 may preferably be chosen based upon the interface of the device with which that particular member 20 is most likely to interact, and the type of hand covering on which the pointer member is most likely to be provided. For example, end 21a of pointer member 20a may be a metallic rectangular element having a larger cross-sectional area (e.g., for interaction with capacitive buttons) than that of end 21d of pointer member 20d, which may be very thin and made of hard plastic (e.g., for interaction with a touchscreen).

The location of pointer member 20 on glove 10 preferably may be, but is not limited to, the front of a digit covering portion (see, e.g., member 20a), the back of a digit covering portion (see, e.g., members 20b), the side of a digit covering portion (see, e.g., member 20c), and/or the top of a digit covering portion (see, e.g., members 20d). In a preferred embodiment, only one pointer member 20 is provided on glove 10 (e.g., member 20d on the tip of index finger covering portion 16), so as to minimize the amount of protrusions and variations made to the normal shape of a glove. In another preferred embodiment, a plurality of pointer members 20 are provided on glove 10, each preferably differing from the others in size, shape, material, and/or placement, such that a selection of pointer members 20 varying in orientation, length, and relative fineness at the point of contact with the device to be manipulated may be available to the user on one hand covering.

As mentioned, each pointer member 20 may be formed from any suitable material, such as, but not limited to, plastic, fiber composite, ceramics, rubber, metal, or any combinations thereof. Pointer members 20 may be formed of any suitable size, shape, and length, preferably depending not only on the various types of devices with which they will interact (e.g., the buttons, trackpads, and touchscreens of PDAs and cellular telephones), but also on the size, shape, and type of the hand covering as well as the orientation of the other input gesture features thereon. For example, a pointer member 20, which is desired to be maneuvered by a user to effectively make input gestures for manipulating a pressure-sensitive touchscreen, is preferably formed to extend a sufficient length from glove 10 at an appropriate angle, such that glove 10 is prevented from obscuring the user's view of both the screen and pointer member 20 while being maneuvered by the user. Preferably, the cross-sectional area of end 21 of a pointer member 20 is small enough such that it does not interfere with the user's ability to view the interface it is manipulating.

Furthermore, pointer members 20 of the present invention may be provided on glove 10 by any suitable process, such as, but not limited to, integration into the material(s) of coverings 14-19, localized treatment of the material(s) of coverings 14-19, adhesive coating on the material(s) of coverings 14-19, inserts that are either permanently or temporarily attached to or through the inside, outside, or layerings of coverings 14-19, stitching into the material(s) of coverings 14-19, or any combinations thereof.

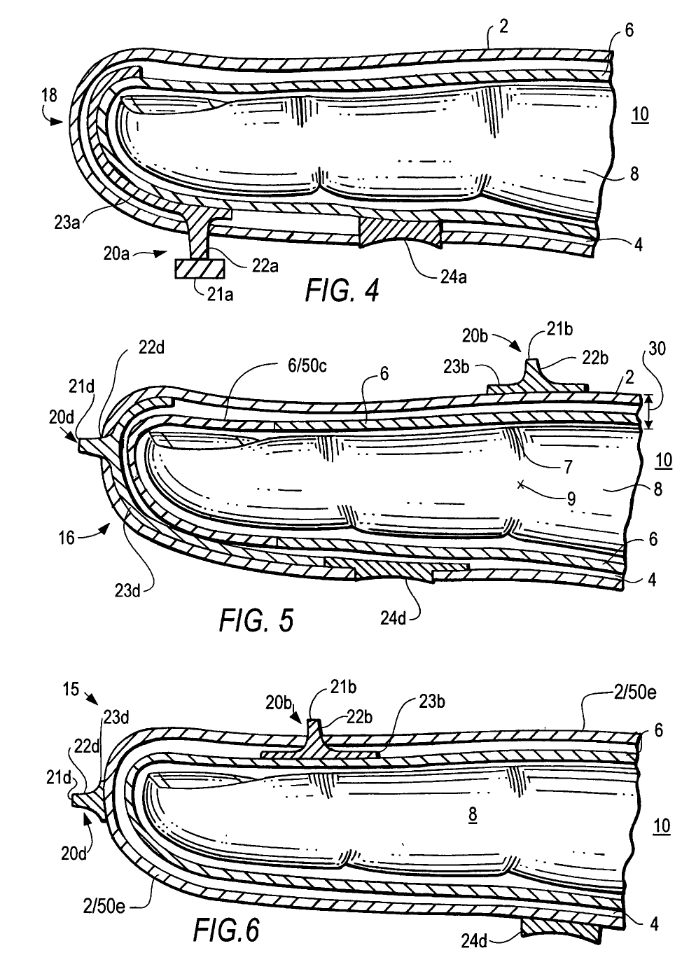

As shown in FIGS. 4-10 and 12, portions of glove 10 are shown in cross-section to illustrate an example of a typical layered construction of the hand covering and various features of pointer members 20a-d, in accordance with the present invention. Glove 10 may include a shell or outer-lining layer 2, an insulating layer 4, and an inner-lining 6. There is also shown in each of FIGS. 4-10 and 12 a user's digit 8 inserted within each one of digit portions 15-19. It is to be understood, however, that hand coverings may be constructed of only one layer, or more than three layers, without departing from the sprit and scope of the present invention.

In some embodiments, a pointer member 20 may include, at and end of body 22 generally opposite to end 21, a base structure 23 that generally supports member 20 and couples it to the hand covering (i.e., glove 10). Preferably, base structure 23 at least partially conforms to the shape of the user's digit 8, such that when he or she attempts to make an input gesture with a particular pointer member 20, the associated digit 8 exerts an appropriate force on base structure 23, through body 20, to cause contact end 21 to effectively manipulate a device according to the desired input gesture. Preferably, each base structure 23 may be integral with its respective body 20, and formed from any suitable material, such as, but not limited to, plastic, rubber, ceramics, metal, or any combinations thereof.

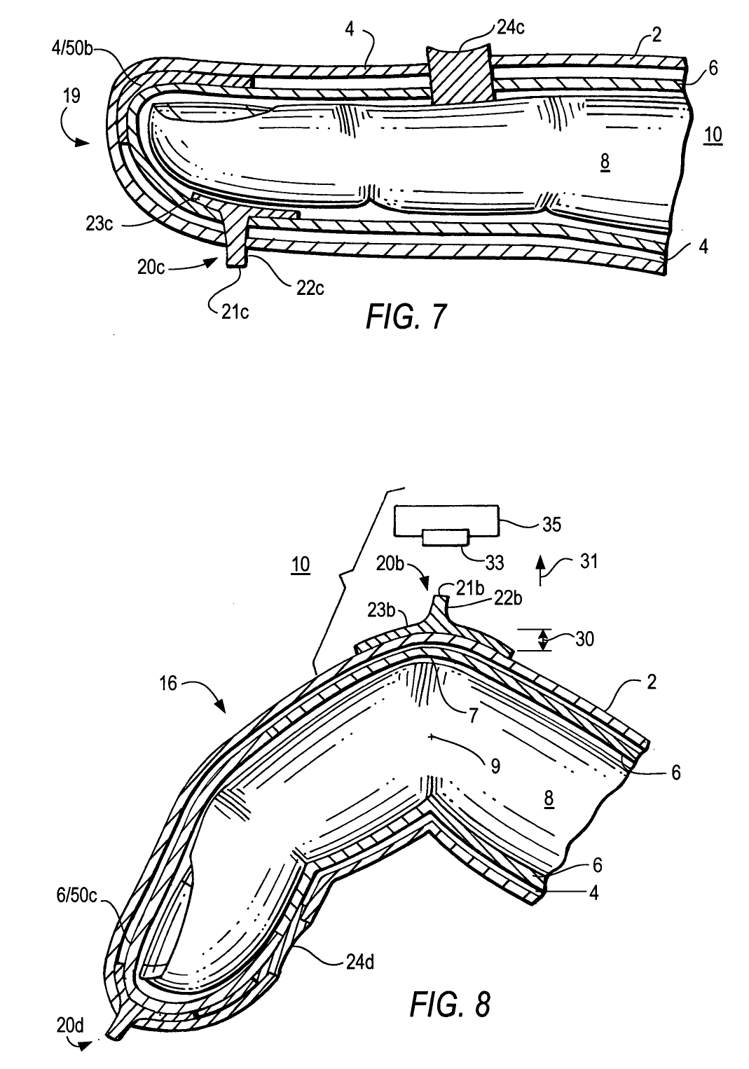

Base structures 23 may be coupled to glove 10 in many different places in accordance with present invention, such as, but not limited to, within insulating layer 4 along inner-lining 6 (see, e.g., FIG. 4, base structure 23a), within insulating layer 4 along outer-lining 2 (see, e.g., FIG. 5, base structure 23d), along outer lining 2 external to glove 10 (see, e.g., FIG. 6, base structure 23d), or along inner-lining 6 internal to glove 10 (see, e.g., FIG. 7, base structure 23c). In a preferred embodiment, base structure 23 may be sized such that it forms a tight fit about the portion of the user's digit by which it is to be moved for manipulating a device. For example, with respect to FIG. 4, base structure 23a is preferably made of a stretchy material or otherwise sized to tightly surround user's digit 8, such that the user is able to more effectively control contact end 21a of pointer member 20a. Each base structure 23 may be attached to glove 10, in any of the places described above, for example, through removeably connectable parts, stitching, adhesives, plastic welding, chemical bonding, or hook and loop material, such as Velcro®, or any combinations thereof, for example.

As is well known, when a user wearing a glove bends a digit at a joint, the associated knuckle tends to stretch or tighten the covering portion adjacent thereto. In a preferred embodiment of the present invention, a pointer member 20 is preferably provided on a digit covering portion 15-19 such that a knuckle of the user's digit associated with that covering portion is adjacent the pointer member (see, e.g., FIGS. 1, 3, 5, and 8, digit covering portion 16, pointer member 20b, and knuckle 7 of digit 8 at joint 9). For example, as shown in FIG. 8, when digit 8 is bent at joint 9, digit covering portion 16 of glove 10 adjacent to knuckle 7 is pulled taught, thereby forcing base structure 23b of pointer member 20b towards knuckle 7, and thereby reducing the distance 30 between pointer member 20b and digit 8. Preferably, base structure 23b is made of a material that is sufficiently flexible, such that its shape adjusts to the contours of knuckle 7 of digit 8. This gesticulation provides the user with the ability to more adroitly control contact end 21b of pointer member 20b for making effective input gestures to manipulate a small device therewith (e.g., moving knuckle 7, and thereby end 21b, in the direction of arrow 31, to depress button 33 of cellular telephone 35, for example).

One or more of digit covering portions 15-19 of hand covering 10 is also preferably provided with one or more digit cradles 24 that may receive a portion of another digit covering portion 15-19, as described herein below in more detail. Each digit cradle 24, in accordance with the present invention, may be coupled to a base structure 23 of a particular pointer member 20 (see, e.g., FIG. 5, cradle 24d) or may be an independent element (see, e.g., FIG. 4, cradle 24a). Moreover, each digit cradle 24, in accordance with the present invention, may be coupled to glove 10 in any of the different places described above with respect to base structures 23, such as, but not limited to, within insulating layer 4 along inner-lining 6 (see, e.g., FIG. 4, digit cradle 24a), within insulating layer 4 along outer-lining 2 (see, e.g., FIG. 5, digit cradle 24d), along outer lining 2 external to glove 10 (see, e.g., FIG. 6, digit cradle 24d), or along inner-lining 6 internal to glove 10 (see, e.g., FIG. 7, digit cradle 24c). Each digit cradle 24 may be attached to glove 10, in any of the places described above, for example, through any suitable process, such as, but not limited to, removeably connectable parts, stitching, adhesives, plastic welding, chemical bonding, or hook and loop material, such as Velcro®, or any combinations thereof, in accordance with the present invention. Moreover, each digit cradle 24 may be formed from any suitable material, such as, but not limited to, plastic, ceramics, rubber, metal, or any combinations thereof, in accordance with the present invention.

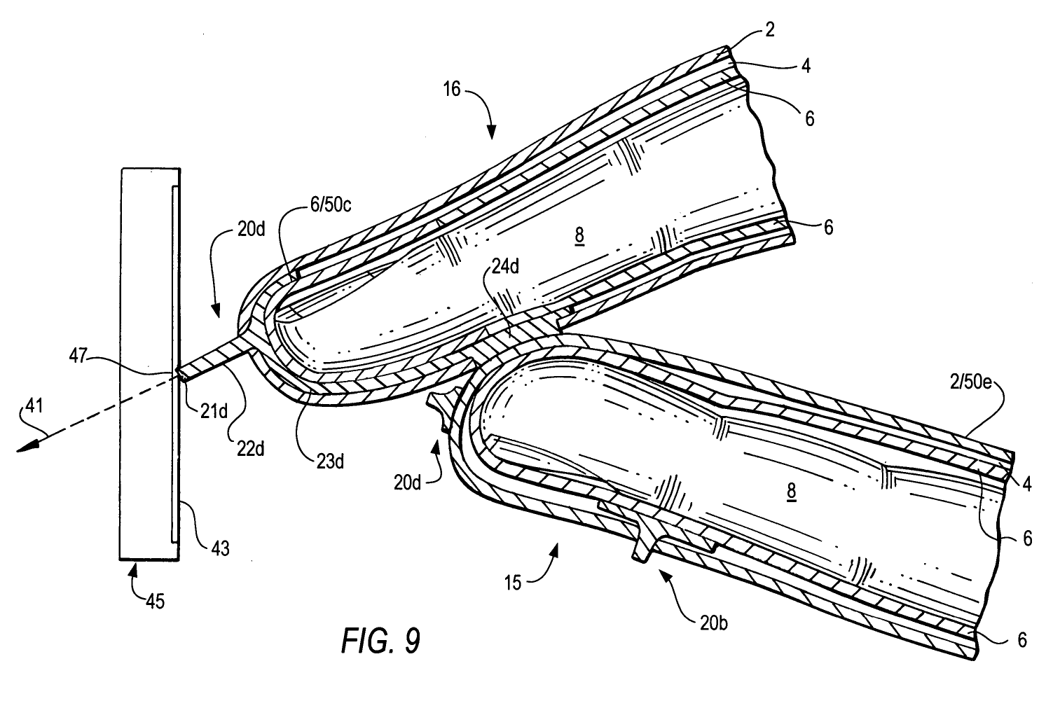

As is well known, when a user presses one digit against another digit, each of these two digits is significantly more stable. In a preferred embodiment of the present invention, a digit cradle 24 of one digit covering portion 15-19 is preferably provided at a location thereon that is conducive to interacting with another digit covering portion to help the user control the movement of at least one pointing member 20 provided on one of the two interacting digit covering portions (see, e.g., FIGS. 1, 5, 6, and 9, pointer member 20d and digit cradle 24d of digit covering portion 16, and digit covering portion 15). For example, as shown in FIG. 9, when a user moves digit 8 within covering portion 15 and digit 8 within covering portion 16 towards each other in the direction of arrows 25 and 26, respectively (see FIG. 1), digit 8 of covering portion 15 is pressed into cradle 24d of covering portion 16. Cradle 24d provides the user with a tactile, visible, and, preferably, frictional contact area at which digit 8 of covering portion 15 may press against digit 8 of covering portion 16, thereby increasing the stability of each of the two digits. This gesticulation provides the user with the ability to more adroitly control contact end 21d of pointer member 20d of covering portion 16 for making effective input gestures to manipulate a small device therewith (e.g., simultaneously moving the united digits 8 of covering portions 15 and 16, and thereby end 21d of member 20d of covering portion 16, in the direction of arrow 41 to contact touchscreen 43 of PDA 45 at location 47, for example). When a digit cradle 24 is integral with base structure 23 of a pointer member 20 (e.g., cradle 24d and base structure 23d of pointer member 20d of digit covering portion 16), the user's ability to control that pointer member is even further increased.

While any of the above-described pointer members 20 in accordance with the present invention may allow a user wearing glove 10 to effectively make input gestures for manipulating small mechanical buttons or touch-sensing interfaces of the resistive type, with which it does not matter if the user touches the screen or pad with a non-conductive object, additional steps must be taken to assure that glove 10 is provided with input gesture features that allow the user to effectively interact with all interfaces, including capacitive systems that require a conductive input gesture feature in order to register a touch.

In accordance with a preferred embodiment of the present invention, one or more portions of hand covering or glove 10 is provided with an instance of conductive material 50 (see FIGS. 1-3 and 5-12). Preferably, each instance of conductive material 50 is provided to a particular covering portion of glove 10 such that, when the outer-most lining of that covering portion touches a conductive touch-sensing interface, the instance of conductive material 50 effectively transfers the required amount of charge between the conductive touch-sensing interface and the user's digit associated with that glove portion for manipulating that interface. This enables movement of the user's digit associated with that covering portion and instance of conductive material 50 to accordingly maneuver the instance of material 50 to make effective input gestures for manipulating a small device with a conductive touch-sensing interface without requiring removal of the hand covering.

It is to be appreciated that the size, shape, and composition of each instance of conductive material 50 may preferably be chosen based not only upon the interface of the device with which that particular instance of conductive material 50 is most likely to interact but also upon the type of hand covering being used.

As mentioned, each instance of conductive material 50 may be formed from any suitable conductive substance, such as, but not limited to, plastics, metals, or any conductive combinations thereof. Instances of conductive material 50 may be formed of any suitable size, shape, and length, preferably depending not only on the various types of devices with which they will interact (e.g., the buttons, trackpads, and touchscreens of PDAs and cellular telephones), but also on the size, shape, and type of the hand covering as well as the orientation of the instances 50 thereon. Furthermore, each instance of conductive material 50 of the present invention may be provided on glove 10 by any suitable process, such as, but not limited to, integration into the material(s) of any of the layers 2/4/6 of coverings 14-19, localized treatment of the material(s) of coverings 14-19, adhesive coating on the material(s) of coverings 14-19, inserts that are either permanently or temporarily attached to or through the inside, outside, or layerings of coverings 14-19, stitching into the material(s) of coverings 14-19, or any combinations thereof.

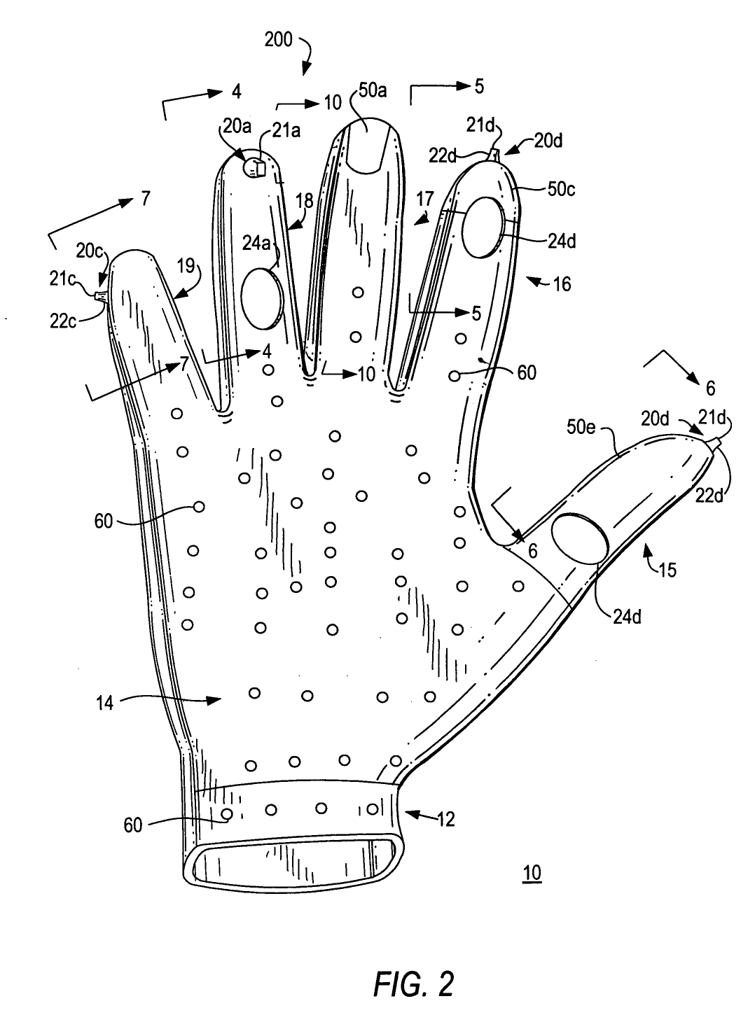

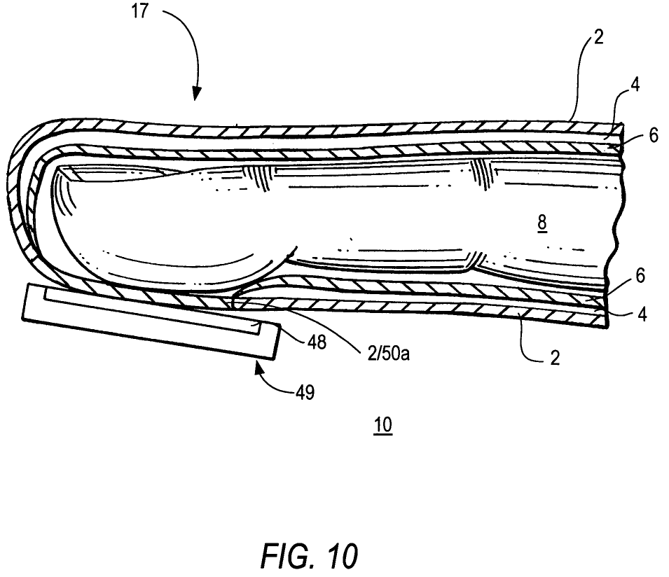

The location of an instance of conductive material 50 on glove 10 may preferably be, but is not limited to, only the front tip of a digit covering portion (see, e.g., FIGS. 2 and 10, instance 50a within or on a portion of outer-layer 2), only the back tip of a digit covering portion (see, e.g., FIGS. 1, 3, and 7, instance 50b within or on a portion of insulation layer 4), about the whole tip of a digit covering portion (see, e.g., FIGS. 1-3, 5, and 9, member 50c within or on a portion of inner-layer 6), or the entire digit covering portion (see, e.g., FIGS. 1-3, 6, and 9, member 50e within or on outer-layer 2). In a preferred embodiment, only one instance of conductive material 50 is provided on glove 10 (e.g., 50c on the tip of index finger covering portion 16), so as to minimize the amount of charges flowing through various conductive portions of the glove. In another preferred embodiment, a plurality of instances of conductive material 50 are provided on glove 10, each preferably differing from the others in size, shape, composition, and placement, such that a selection of instances 50 varying in orientation and relative size at the point of contact with the device to be manipulated may be available to the user on one hand covering.

It should be noted that non-conductive materials may be situated between a user and an instance of conductive material 50 (see, e.g., FIG. 7, inner-layer 6 between digit 8 and the instance of conductive material 50b) or between an instance of conductive material 50 and the exterior of the hand covering (see, e.g., FIG. 7, outer-layer 2 between digit 8 and the instance of conductive material 50b) without destroying the effectiveness of the instance of conductive material 50 to transfer electrical charge between the user and a capacitive interface of a device, depending upon the conductivity strength of instance 50 and the non-conductivity strength of the non-conductive materials between the user and the exterior of the hand covering, for example.

However, in a preferred embodiment of the present invention, certain portions of certain layers of digit covering portions 15-19 of hand covering 10 may be removed such that an instance of conductive material 50 may be integrated into the only layer between a user and the exterior of the hand covering, as shown, for example, in FIG. 10. In this preferred embodiment, instance of conductive material 50a is provided within or on a portion of outer-layer 2 at a location of digit covering portion 17 where insulating layer 4 and inner-layer 6 have been discontinued. This embodiment of the present invention not only allows for user's digit 8 to be in direct contact with instance of conductive material 50a, but also for instance of conductive material 50a to be in direct contact with the capacitive interface of a device (see, e.g., FIG. 10, capacitive trackpad 48 of device 49), for example, thereby maximizing the effectiveness of instance of conductive material 50a to transfer electrical charge between the user and the capacitive interface. This embodiment may also increase the tactile sensitivity of user's digit 8 in digit covering portion 17 by minimizing the amount of layered hand covering material between the user and the device to be manipulated. It is to be understood that, in certain embodiments of the present invention, layer 2/50a of FIG. 10 could be the only layer of material provided by hand covering 10, or layers 4 and 6 could continue throughout the instance of conductive material 50a, without departing from the spirit and scope of the present invention.

In a preferred embodiment of the present invention, an instance of conductive material 50 on glove 10 may be a layer of conductive material, such as silver, bonded to the surface of a textile fiber found in the material of any known hand covering layer, such that the fiber, with its conductive layer, retains traditional textile and tactile characteristics while also being able to sufficiently transfer electrical charge therethrough (e.g., X-static®, manufactured by Noble Fiber Technologies of Clarks Summit, Pa.). This embodiment of an instance of conductive material 50 is particularly useful on hand coverings constructed of one layer of material or with a plurality of relatively thin layers of material, which do not significantly increase the workable surface of a user's fingertip, such that certain capacitive buttons, touchscreens, and trackpads may be manipulated by the user through the conductive material 50 of the hand covering layer (see, e.g., FIG. 10, instance of conductive material 50a). This embodiment of an instance of conductive material 50 as conductive thread may also preferably be used to sew other instances of conductive material 50 or pointer members 20 to hand covering 10, such that conductive material 50 may preferably be in direct contact with the user through the sewn seams of the hand covering, for example.

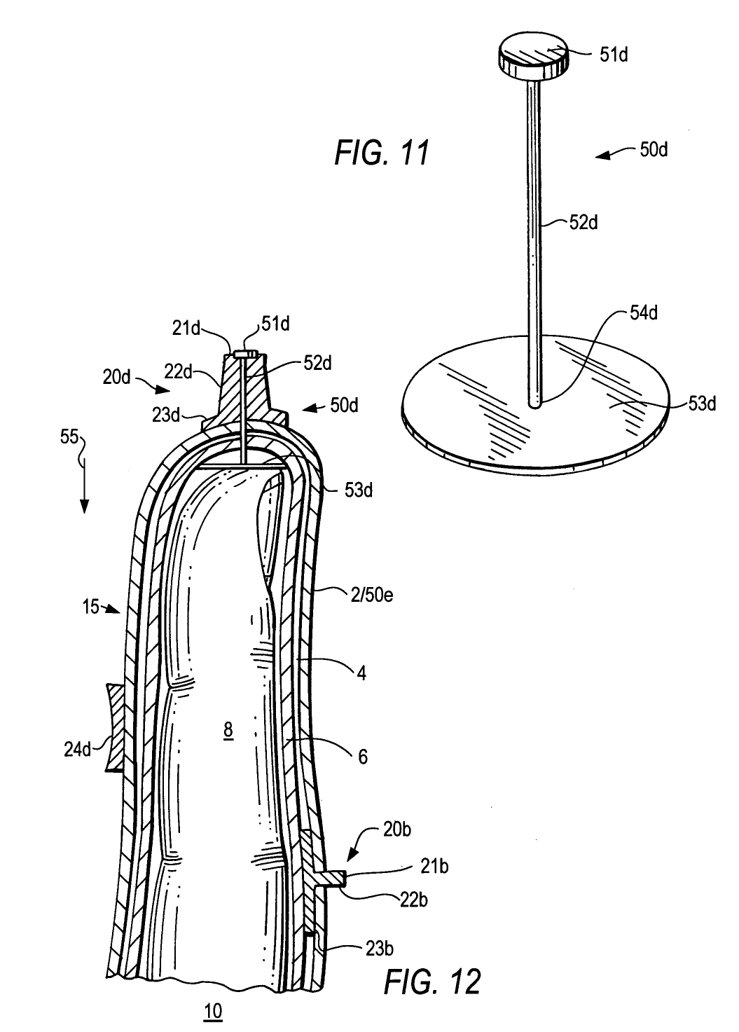

In another preferred embodiment of the present invention, an instance of conductive material 50 may be provided in one or more of the pointer members 20 of the present invention, described above, thereby enhancing pointer members 20 to allow a user wearing glove 10 to effectively make input gestures for manipulating small capacitive buttons or touch-sensing interfaces of the capacitive type, as well as buttons and interfaces of the resistive type. Preferably, a pointer member 20 may be constructed, at least partially, of a conductive material. For example, instance of conductive material 50 may be provided as a rod (e.g., made of silver) running through the length of body 22 of a pointer member 20 from contact end 21 to base 23, and preferably through base 23 such that an end of the rod may contact a digit of the user. As illustrated in FIGS. 11 and 12, instance of conductive material 50d may be incorporated into pointing member 20d of digit covering portion 15. Instance of conductive material 50d preferably includes a device contact end 51d and a user contact end 53d on either side of conductive rod 52d. When incorporated into pointer member 20d, contact end 51d may rest on contact end 21d, while user contact end 53d is provided internally of digit covering portion 15 for contacting user's digit 8. Therefore, when pointing member 21d is utilized by the user to manipulate a device, as described above, instance of conductive material 50d may effectively transfer electrical charge between a capacitive interface and digit 8 through conductive rod 52d.

While any of the above described embodiments of pointer members 20 and instances of conductive material 50 may be incorporated on a hand covering during its manufacture, each of these input gesture features may preferably be manufactured independently and provided on any known glove by its user. As an example, with continued reference to FIGS. 11 and 12, user contact end 53d of instance of conductive material 50d may preferably be removeably coupled to rod 52d at point 54d, while rod 52d and contact end 51d may be fixed to pointer member 20d. Point 54d of rod 52d may preferably be sharp enough to pierce through the layered construction of hand covering 10 (e.g., layers 2, 4, and 6) in the direction of arrow 55 and couple to end 53d provided therein.

In a preferred embodiment of the present invention, hand covering or glove 10 is preferably provided with one or more grip members 60 (see FIG. 2) on the front of one or more of wrist covering portion 12, palm covering portion 14, or digit covering portions 15-19. Grip members 60 may preferably be provided to enable the user to more securely grip any suitable object, such as the small devices described above. This is particularly important in conditions where moisture or rain makes the gripping surface slippery. Grip members 60 may be made of any materials suitable for improving the frictional securing force between glove 10 and any device to be manipulated by the user to achieve improved gripping thereof (see, e.g., Taylor U.S. Pat. No. 4,589,146, which is hereby incorporated by reference herein in its entirety). Although grip members 60 are also preferably provided on the counterpart glove to that of glove 10 in a pair of hand coverings for gripping a device to be manipulated by the features of glove 10, grip members are illustrated on glove 10 for the sake of simplicity.

Thus, it is seen that hand covering features that allow a user to effectively make input gestures for manipulating a small device without requiring removal of the hand covering have been provided. It should be noted that the type of hand covering described above (i.e., glove 10) is only exemplary, and that any other type of hand covering may be provided with one or more of the above described input gesture features without departing from the spirit and scope of the present invention. One skilled in the art will appreciate that the present invention can be practiced by other than the described embodiments, which are presented for purposes of illustration and not of limitation, and the present invention is limited only by the claims which follow.

1. A protective hand covering for providing a wearer of said hand covering with the ability to effectively make input gestures for manipulating a device, said hand covering comprising:
at least a first digit covering portion for surrounding a first digit of said wearer; and
a first pointer member extending from said first digit covering portion.

2. The hand covering of claim 1, wherein said first pointer member extends from a portion of said first digit covering portion adjacent a knuckle of said first digit.

3. The hand covering of claim 1, wherein said first pointer member extends from a portion of said first digit covering portion adjacent the top of said first digit.

4. The hand covering of claim 1, wherein said first pointer member extends from a portion of said first digit covering portion adjacent the front tip of said first digit.

5. The hand covering of claim 1, wherein said first pointer member extends from a portion of said first digit covering portion adjacent a side of said first digit.

6. The hand covering of claim 1, wherein said first pointer member comprises:
a base structure coupled to said first digit covering portion; and
a longitudinal body structure, wherein said body structure has a first end for contacting said device, and wherein said body structure has a second end opposite said first end for coupling said body structure to said base structure.

7. The hand covering of claim 6, wherein the construction of said first digit covering portion comprises:
an inner-lining for surrounding said first digit;
an outer-lining surrounding said inner lining; and
an insulating layer between said inner-lining and said outer-lining, wherein said base structure is coupled to said first digit covering portion at one location from the group consisting of the following: (1) along said inner-lining internal to said hand covering, (2) within said insulating layer along said inner-lining, (3) within said insulating layer along said outer-lining, and (4) along said outer-lining external to said hand covering.

8. The hand covering of claim 1 further comprising a first instance of conductive material.

9. The hand covering of claim 8, wherein said first instance of conductive material is provided at a portion of said first digit covering portion adjacent the front tip of said first digit.

10. The hand covering of claim 8, wherein said first instance of conductive material is provided at a portion of said first digit covering portion adjacent the entire tip of said first digit.

11. The hand covering of claim 8, wherein said first instance of conductive material is provided throughout the entire first digit covering portion.

12. The hand covering of claim 8, wherein said first instance of conductive material is provided by said first pointer member.

13. The hand covering of claim 8 further comprising a second digit covering portion for surrounding a second digit of said wearer, wherein said first instance of conductive material is provided on said second digit covering portion.

14. The hand covering of claim 8, wherein, when said hand covering is in contact with a capacitive interface of said device, said first instance of conductive material effectively transfers a required amount of charge between said interface and said wearer.

15. The hand covering of claim 14, wherein at least a first portion of said hand covering comprises a single lining having at least one textile fiber, wherein said first instance of conductive material is bonded to the surface of said at least one textile fiber.

16. The hand covering of claim 14, wherein the construction of said first digit covering portion comprises:
an inner-lining for surrounding said first digit of said wearer;
an outer-lining surrounding said inner lining; and
an insulating layer between said inner-lining and said outer-lining, wherein said first instance of conductive material is provided on said first digit covering portion at one location from the group consisting of the following: (1) along said inner-lining internal to said hand covering, (2) within said insulating layer along said inner-lining, (3) within said insulating layer along said outer-lining, and (4) along said outer-lining external to said hand covering.

17. The hand covering of claim 1 further comprising a digit cradle provided on said first digit covering portion.

18. A protective hand covering for providing a wearer of said hand covering with the ability to effectively make input gestures for manipulating a device, said hand covering comprising:
at least a first digit covering portion for surrounding a first digit of said wearer; and
at least one of the input gesture features from the group consisting of the following: (1) a first pointer member extending from said first digit covering portion, and (2) a first instance of conductive material provided on said first digit covering portion.

19. The hand covering of claim 18, wherein said hand covering includes a plurality of digit covering portions, and wherein at least one of said input gesture features is provided on each of said digit covering portions.

20. An input gesture feature for providing to a wearer of a protective hand covering the ability to effectively make input gestures for manipulating a device, said hand covering having at least a first digit covering portion for surrounding a first digit of said wearer, said input gesture feature comprising:
a first pointer member, wherein said first pointer member comprises:
a longitudinal body structure, wherein said body structure has a first end for contacting said device and a second end opposite said first end; and
a base structure connectable to said second end of said body structure for attaching said body structure to said first digit covering portion.
